(19) United States
(12) Patent Application Publication
(10) Pub. No.: US 2018/0114651 A1
(43) Pub. Date: Apr. 26, 2018

(54) NONAQUEOUS ELECTROLYTE, AND LITHIUM-ION SECONDARY CELL AND LITHIUM-ION CAPACITOR IN WHICH SAME IS USED

(71) Applicant: UBE INDUSTRIES, LTD., Ube-shi (JP)

(72) Inventors: Kei SHIMAMOTO, Sakai-shi (JP); Yousuke KISHIDA, Shimonoseki-shi (JP)

(73) Assignee: UBE INDUSTRIES, LTD., Ube-shi (JP)

(21) Appl. No.: 15/566,023

(22) PCT Filed: Nov. 16, 2015
(86) PCT No.: PCT/JP2015/082105

§ 371 Date: Oct. 12, 2017

(30) Foreign Application Priority Data
Apr. 17, 2015 (JP) 2015-084921

(51) Int. Cl. H01G 11/60; H01M 10/0525; H01M 10/0568; H01M 10/0567; H01M 10/0569

(52) U.S. Cl. CPC H01G 11/60; H01M 10/0525; H01M 2300/0037; H01M 10/0567; H01M 10/0569; H01M 10/0568

(57) ABSTRACT

Provided are (1) a nonaqueous electrolytic solution having lithium hexafluorophosphate dissolved in a nonaqueous solvent containing a cyclic carbonate and a linear carbonate, the nonaqueous electrolytic solution including, as a dissolution aid of lithium difluorophosphate, a linear ether compound containing a methoxy group and having a carbon number of 2 or more, a ratio (% by volume/% by mass) of a proportion (% by volume) of the dissolution aid to the total volume of the nonaqueous solvent to an amount (% by mass) of lithium difluorophosphate in the nonaqueous electrolytic solution being 0.1 or more and 5 or less, and lithium difluorophosphate being dissolved in an amount of 1.2% by mass or more at 25° C.; and (2) a lithium secondary battery and a lithium ion capacitor each using the nonaqueous electrolytic solution. The nonaqueous electrolytic solution is excellent in output characteristics and high temperature cyclic property and is capable of suppressing a metal elution amount.

### TECHNICAL FIELD

The present invention relates to a nonaqueous electrolytic solution that is excellent in high-temperature cycle property and output characteristics after high-temperature cycles and is capable of suppressing elution of a metal from a positive electrode or the like, and to a lithium ion secondary battery and a lithium ion capacitor each using the nonaqueous electrolytic solution.

### BACKGROUND ART

Attention has been paid recently to a power source for an automobile, such as an electric vehicle, a hybrid car, etc., and a lithium ion secondary battery and a lithium ion capacitor for idling stop.

As an electrolytic solution of a lithium secondary battery, a nonaqueous electrolytic solution in which an electrolyte, such as LiPF₆, LiBF₄ , etc. is dissolved in a cyclic carbonate, such as ethylene carbonate, propylene carbonate, etc., and a linear carbonate, such as dimethyl carbonate, diethyl carbonate, ethyl methyl carbonate, etc. is used.

In order to improve battery characteristics of such a lithium secondary battery, such as load characteristics, cycle property, etc., various investigations regarding a nonaqueous solvent or an electrolyte to be used in such a nonaqueous electrolytic solution have been made.

For example, PTL 1 describes that an electrolytic solution containing a compound having a skeleton including a hetero element, the compound being a liquid at 25° C. and having a dielectric constant of 5 or more and a viscosity rate of 0.6 cP or less, such as dimethoxyethane, diethoxyethane, acetonitrile, etc., as well as lithium difluorophosphate (LiPO₂F₂) suppresses degradation of battery characteristics at the time of high-temperature storage. However, a mixing ratio of dimethoxyethane and lithium difluorophosphate is not investigated. In addition, a suitable mixing amount of dimethoxyethane is not described, and any investigation regarding solubility of lithium difluorophosphate is not made, too.

In addition, in PTL 2, a nonaqueous electrolytic solution including lithium difluorophosphate is disclosed, and in Example 3 thereof, an example in which 4.6% by mass of lithium difluorophosphate was added is described.

### CITATION LIST

### Patent Literature

PTL 1: JP 2008-277002 A

PTL 2: JP 2008-222484 A

### DISCLOSURE OF INVENTION

### Technical Problem

If lithium difluorophosphate is contained in a nonaqueous electrolytic solution, though high-temperature storage property or cycle property is improved to some extent, there was involved such a problem that an improving effect of output characteristics is still insufficient.

In PTL 1, though lithium difluorophosphate and dimethoxyethane or the like are mixed, a suitable mixing proportion is not described, and these are merely added for the purpose of decreasing the viscosity of the electrolytic solution.

In a hybrid car or an electric vehicle, a requirement for an improvement of output characteristics is increasing more and more. So long as there would be a technology capable of uniformly completely dissolving lithium difluorophosphate in an amount largely exceeding the conventional solubility, the output characteristics will be able to be increased to a higher level.

In Example 3 of PTL 2, 4.6% by mass of lithium difluorophosphate is added in the nonaqueous electrolytic solution including a cyclic carbonate and a linear carbonate. But, according to this way, the lithium difluorophosphate cannot be uniformly completely dissolved. In addition, PTL 2 does not describe at all that dimethoxyethane and lithium difluorophosphate are used in combination.

In view of the foregoing background technologies, a problem of the present invention is to provide a nonaqueous electrolytic solution that is excellent in high-temperature cycle property and output characteristics after high-temperature cycles and is capable of suppressing elution of a metal from a positive electrode or the like.

### Solution to Problem

The present inventors made extensive and intensive investigations regarding the aforementioned problems, and as a result thereof, have found that by using a lithium difluorophosphate dissolution aid composed of a linear ether compound containing a methoxy group and having a carbon number of 2 or more in a nonaqueous electrolytic solution, lithium difluorophosphate in an amount largely exceeding the conventional solubility can be uniformly completely dissolved in the nonaqueous electrolytic solution, and have been able to find out an electrolytic solution composition region that is excellent in high-temperature cycle property and output characteristics after high-temperature cycles, thereby leading to accomplishment of the present invention.

Specifically, the present invention provides the following (1) to (3).

(1) A nonaqueous electrolytic solution having lithium hexafluorophosphate dissolved in a nonaqueous solvent containing a cyclic carbonate and a linear carbonate,

the nonaqueous electrolytic, solution including, as a dissolution aid of lithium difluorophosphate, a linear ether compound containing a methoxy group and having a carbon number of 2 or more, in particular, including, as the dissolution aid of lithium difluorophosphate, at least one selected from triethylene glycol dimethyl ether and tetraethylene glycol dimethyl ether; a ratio (% by volume/% by mass) of a proportion (% by volume) of the dissolution aid to the total volume of the nonaqueous solvent to an amount (% by mass) of lithium difluorophosphate in the nonaqueous electrolytic solution being 0.1 or more and 5 or less; and lithium difluorophosphate being dissolved in an amount of 1.2% by mass or more at 25° C.

(2) A lithium ion secondary battery using the nonaqueous electrolytic solution as set forth in the above item (1).
(3) A lithium ion capacitor using the nonaqueous electrolytic solution as set forth in the above item (1).

### Advantageous Effects of Invention

In accordance with the present invention, it is possible to provide a nonaqueous electrolytic solution that is excellent in high-temperature cycle property and output characteristics after high-temperature cycles and is capable of suppressing elution of a metal from a positive electrode or the like, and a lithium ion secondary battery and a lithium ion capacitor each using the nonaqueous electrolytic solution.

In addition, the nonaqueous electrolytic solution of the present invention has an energy-saving effect because it is able to provide a lithium ion secondary battery and a lithium ion capacitor each having excellent electrochemical characteristics, such as cycle property, etc.

### DESCRIPTION OF EMBODIMENTS

### [Nonaqueous Electrolytic Solution]

The nonaqueous electrolytic solution of the present invention is a nonaqueous electrolytic solution having lithium hexafluorophosphate (electrolyte salt: LiPF₆) dissolved in a nonaqueous solvent containing a cyclic carbonate and a linear carbonate, the nonaqueous electrolytic solution including, as a dissolution aid (hereinafter also referred to simply as “dissolution aid”) of lithium difluorophosphate, a linear ether compound containing a methoxy group and having a carbon number of 2 or more, in particular, including, as the dissolution aid of lithium difluorophosphate, at least one selected from triethylene glycol dimethyl ether and tetraethylene glycol dimethyl ether; a ratio (% by volume/% by mass) of a proportion (% by volume) of the dissolution aid to the total volume of the nonaqueous solvent to an amount (% by mass) of lithium difluorophosphate in the nonaqueous electrolytic solution being 0.1 or more and 5 or less; and lithium difluorophosphate being dissolved in an amount of 1.2% by mass or more at 25° C.

From the viewpoint of a balance between improvement of output characteristics and suppression of metal elution, the aforementioned ratio (% by volume/% by mass) is preferably 0.2 or more, more preferably 0.3 or more, and still more preferably 0.4 or more, and the upper limit thereof is preferably 4 or less, more preferably 3 or less, still more preferably 2.6 or less, and yet still more preferably 2.5 or less.

The lower limit of the amount of lithium difluorophosphate dissolved in the nonaqueous electrolytic solution at 25° C. is preferably 1.5% by mass or more, more preferably 1.7% by mass or more, and still more preferably 1.9% by mass or more. In addition, from the viewpoint of a balance between improvements of high-temperature cycle property and output characteristics after high-temperature cycles and suppression of metal elution, an upper limit thereof is preferably 10% by mass or less, more preferably 7% by mass or less, still more preferably 5% by mass or less, yet still more preferably 4% by mass or less, and especially preferably 2.5% by mass or less.

Although the reasons why the nonaqueous electrolytic solution of the present invention is excellent in high-temperature cycle property and output characteristics after high-temperature cycles and is capable of suppressing metal elution from a positive electrode or the like are not always elucidated yet, the following may be considered.

The nonaqueous electrolytic solution of the present invention contains lithium difluorophosphate and, as a dissolution aid of lithium difluorophosphate, a linear ether compound containing a methoxy group and having a carbon number of 2 or more, particularly at least one selected from triethylene glycol dimethyl ether and tetraethylene glycol dimethyl ether in a specified ratio. The aforementioned dissolution aid strongly interacts with lithium difluorophosphate and is decomposed on a surface of a positive electrode to form a firm surface film with high heat resistance on the positive electrode. It may be considered that the aforementioned dissolution aid and lithium difluorophosphate form a pentadentate complex, and the complex exists in an amount of several times of the amount of lithium difluorophosphate dissolved in the conventional nonaqueous electrolytic solution. Therefore, it may be considered that an effect that is not seen in the case where the aforementioned dissolution aid and lithium difluorophosphate are each independently existent is exhibited, and the high-temperature cycle property and the output characteristics after high-temperature cycles are improved, and at the same time, a metal elution from the positive electrode or the like may be suppressed.

### (Preparation Method of Nonaqueous Electrolytic Solution)

In the nonaqueous electrolytic solution of the present invention, a mixing proportion of lithium difluorophosphate and the dissolution aid is the aforementioned ratio. In the case of preparing a nonaqueous electrolytic solution at 25° C. where lithium difluorophosphate is dissolved in an amount of 1.2% by mass or more, according to a method of mixing the nonaqueous solvents, adding the electrolyte salt thereto, and then adding the dissolution aid and lithium difluorophosphate into the resulting nonaqueous electrolytic solution, it is difficult to completely dissolve lithium difluorophosphate. For that reason, it is preferred to adopt a method in which a liquid composition of a mixture of lithium difluorophosphate and the dissolution aid in a specified molar ratio as described later is prepared in advance, and this composition is added to the nonaqueous electrolytic solution.

When the aforementioned method is adopted, it is possible to completely dissolve lithium difluorophosphate in the nonaqueous electrolytic solution, and in the case of using an energy storage device at a high temperature and a high voltage, there is less concern that the cycle property, the output characteristics after cycles, and the suppression of metal elution from a positive electrode or the like are worsened.

Although the dissolution aid is a linear ether compound containing a methoxy group and having a carbon number of 2 or more, it is preferably a linear ether compound containing 2 or more methoxy groups, more preferably a linear ether compound containing 2 or more methoxy groups, 4 or more carbon atoms, 10 or more hydrogen atoms, and 2 or more oxygen atoms; and still more preferably a specified linear ether compound containing 2 or more methoxy groups, 8 or more carbon atoms, 10 or more hydrogen atoms, and 4 or more oxygen atoms.

From the viewpoints of high-temperature cycle property and output characteristics after high-temperature cycles, a molecular weight of the dissolution aid is preferably 80 or more, more preferably 90 or more, still more preferably 120 or more, and yet still more preferably 140 or more, and an upper limit thereof is preferably 260 or less, more preferably 240 or less, and still more preferably 230 or less.

Specific examples of the dissolution aid include at least one selected from an alkylene glycol dimethyl ether and dimethoxyethane. In addition, the alkylene glycol group in the alkylene glycol dimethyl ether is preferably a triethylene glycol group or a tetraethylene glycol group.

Preferred specific examples of the dissolution aid include at least one selected from triethylene glycol dimethyl ether (same as triglyme), tetraethylene glycol dimethyl ether, and dimethoxyethane, and especially preferred is at least one selected from triethylene glycol dimethyl ether and tetraethylene glycol dimethyl ether.

Since triethylene glycol dimethyl ether contains 4 oxygen atoms in a molecule thereof, it may be considered that in view of the fact that the oxygen atoms are 4-coordinated in the Li ion in a single molecule, and when further including a counter anion, are 5-coordinated, the triethylene glycol dimethyl ether is stabilized, whereby solubility of lithium difluorophosphate (LiPO₂F₂) is improved. In addition, since tetraethylene glycol dimethyl ether contains 5 oxygen atoms in a molecule thereof, it may be considered that in view of the fact that the oxygen atoms are similarly 4-coordinated in the Li ion in a single molecule, the tetraethylene glycol dimethyl ether is stabilized, and in view of the fact that when further including a counter anion, the oxygen atoms are 5-coordinated, the tetraethylene glycol dimethyl ether is stabilized (remaining one oxygen atom does not contribute to the coordination), whereby solubility of lithium difluorophosphate is improved.

In dimethoxyethane or diethylene glycol dimethyl ether, two molecules are coordinated in the Li ion. In the case where two molecules are coordinated in the Li ion, there is steric repulsion between the two molecules to be coordinated. Therefore, dimethoxyethane or diethylene glycol dimethyl ether is inferior in stability of the coordination structure to triethylene glycol dimethyl ether or tetraethylene glycol dimethyl ether in which stability of the coordination structure may be coordinated with one molecule. Thus, it may be considered that dimethoxyethane or diethylene glycol dimethyl ether is inferior in solubility of LiPO₂F₂ to triethylene glycol dimethyl ether or tetraethylene glycol dimethyl ether.

In diethoxyethane in which the methyl group in either end of dimethoxyethane is substituted with an ethyl group, the steric repulsion between the two molecules becomes larger, and the two molecules may not be stably coordinated, and thus, it may be considered that solubility of LiPO₂F₂ is significantly worsened

As for instability of the coordination structure, the steric repulsion in the case where two molecules are coordinated is larger than the steric repulsion in the case where one molecule is coordinated, and therefore, it may be considered that the stability of the complex in the nonaqueous electrolytic solution becomes higher in the order of (two molecules of dimethoxyethane)<<(tetraethylene glycol dimethyl ether)<(triethylene glycol dimethyl ether). As a result, it may be considered that the solubility of LiPO₂F₂ becomes higher in the order of (two molecules of diethylene glycol dimethyl ether)<<(two molecules of dimethoxyethane)<<(tetraethylene glycol dimethyl ether)≤(triethylene glycol dimethyl ether) regarding the dissolution aid used.

In the light of the above, it may be considered that when at least one selected from triethylene glycol dimethyl ether and tetraethylene glycol dimethyl ether is used, there gives rise to a peculiar effect that miscibility of lithium difluorophosphate is remarkably improved.

The content of the dissolution aid in the nonaqueous electrolytic solution is preferably 1.1% by mass or more, more preferably 1.2% by mass or more, and still more preferably 1.5% by mass or more in the nonaqueous electrolytic solution. In addition, an upper limit thereof is preferably 10% by mass or less, more preferably 7% by mass or less, still more preferably 5% by mass or less, and especially preferably 4% by mass or less. When the content of the dissolution aid in the nonaqueous electrolytic solution is 1.1% by mass or more, the metal elution from a positive electrode or the like may be suppressed, whereas when it is 10% by mass or less, there is no concern that the output characteristics after high-temperature cycles are worsened, and hence, such is preferred.

### <Molar Ratio of [(Dissolution Aid)/(Lithium Difluorophosphate)]>

In the nonaqueous electrolytic solution of the present invention, in order to completely dissolve lithium difluorophosphate in the nonaqueous electrolytic solution, it is preferred to prepare a liquid composition of a mixture of lithium difluorophosphate and the dissolution aid in a specified molar ratio in advance.

The molar ratio [(dissolution aid)/(lithium difluorophosphate)] of the dissolution aid to lithium difluorophosphate is preferably 0.1 or more and 2.5 or less. When the aforementioned molar ratio is 2.5 or less, the dissolution aid does not become excessive relative to lithium difluorophosphate, and in particular, electrochemical characteristics, such as cycle property at a high temperature, output characteristics after cycles, etc., are not worsened, and hence, such is desirable.

In the case where the dissolution aid is dimethoxyethane, the aforementioned molar ratio is preferably 0.5 or more, more preferably 1 or more, and still more preferably 1.5 or more. In addition, an upper limit thereof is preferably 2.4 or less, more preferably 2.3 or less, and still more preferably 2 or less.

In the case where the dissolution aid is triethylene glycol dimethyl ether or tetraethylene glycol dimethyl ether, the aforementioned molar ratio is preferably 0.2 or more, more preferably 0.4 or more, still more preferably 0.6 or more, and yet still more preferably 0.7 or more. In addition, an upper limit thereof is preferably 2.0 or less, more preferably 1.5 or less, and still more preferably 1 or less.

### <Mass Ratio of [(Dissolution Aid)/(Lithium Difluorophosphate)]>

In the nonaqueous electrolytic solution of the present invention, a mass ratio [(dissolution aid)/(lithium difluorophosphate)] of the dissolution aid to lithium difluorophosphate is 0.1 or more and 5 or less. When the aforementioned mass ratio is 5 or less, the dissolution aid does not become excessive relative to lithium difluorophosphate, and in particular, electrochemical characteristics, such as cycle property at a high temperature, output characteristics after cycles, etc., are not worsened, and hence, such is desirable.

In the case where the dissolution aid is dimethoxyethane, the aforementioned mass ratio is preferably 0.2 or more, more preferably 0.5 or more, still more preferably 1 or more, and yet still more preferably 1.5 or more. An upper limit thereof is preferably 2.3 or less, and more preferably 2 or less.

In the case where the dissolution aid is triethylene glycol dimethyl ether or tetraethylene glycol dimethyl ether, the aforementioned mass ratio is preferably 0.6 or more, and more preferably 0.7 or more. An upper limit thereof is preferably 4 or less, more preferably 3 or less, still more preferably 2 or less, yet still more preferably 1.5 or less, and even yet still more preferably 1 or less.

### [Nonaqueous Solvent]

The nonaqueous solvent that is used for the nonaqueous electrolytic solution of the present invention contains a cyclic carbonate and a linear carbonate. When both the cyclic carbonate and the linear carbonate are included, electrochemical characteristics in a broad temperature range, particularly cycle property at a high temperature, output characteristics after cycles, etc. can be synergistically improved.

The term “linear ester” as described later is used as a concept including a linear carbonate and a linear carboxylic acid ester.

Examples of the cyclic carbonate include one or more selected from ethylene carbonate (EC), propylene carbonate (PC), 4-fluoro-1,3-dioxolan-2-one (FEC), and vinylene carbonate (VC).

As the combination of cyclic carbonates, a combination of EC and VC, a combination of EC and FEC, and a combination of PC and VC are especially preferred.

When the nonaqueous solvent includes ethylene carbonate and/or propylene carbonate as the cyclic carbonate, the stability of a surface film formed on the electrode increases, and in the case of using an energy storage device at a high temperature and a high voltage, the cycle property, the output characteristics after cycles, and the effect for suppressing metal elution from a positive electrode or the like are improved, and such is preferred. The content of ethylene carbonate and/or propylene carbonate is preferably 3% by volume or more, more preferably 5% by volume or more, and still more preferably 7% by volume or more relative to the total volume of the nonaqueous solvent. In addition, an upper limit thereof is preferably 45% by volume or less, more preferably 40% by volume or less, and still more preferably 35% by volume or less.

Examples of the linear carbonate include an asymmetric linear carbonate and a symmetric linear carbonate.

As the asymmetric linear carbonate, methyl ethyl carbonate (MEC) is preferred, and as the symmetric linear carbonate, one or more selected from dimethyl carbonate (DMC) and diethyl carbonate (DEC) are preferred.

In the present invention, it is preferred that a linear carboxylic acid ester is further included.

As the linear carboxylic acid ester, one or more selected from ethyl acetate (EA), methyl methoxyacetate, and ethyl methoxyacetate are preferred, and ethyl acetate is more preferred.

Among the aforementioned linear esters (combinations of a linear carbonate and a linear carboxylic acid ester), a combination that is asymmetric and contains an ethoxy group, such as a combination of MEC and an acetic acid ester, is preferred, and a combination of MEC and ethyl acetate is especially preferred.

Although the content of the linear carbonate is not particularly limited, it is preferred to use the linear carbonate in the content ranging from 60 to 90% by volume relative to the total volume of the nonaqueous solvent. When the content is 60% by volume or more, the viscosity of the nonaqueous electrolytic solution does not become excessively high, whereas when it is 90% by volume or less, there is less concern that an electroconductivity of the nonaqueous electrolytic solution is decreased to cause the electrochemical characteristics in a broad temperature range, particularly cycle property at a high temperature, output characteristics after cycles, etc., to be worsened, and hence, the aforementioned range is preferred.

When the linear ester is considered as a concept including the linear carbonate and the linear carboxylic acid ester, the content of the linear ester is the same as the content of the linear carbonate as described above.

A proportion of the volume occupied by ethyl acetate (EA) in the linear ester is preferably 1% by volume or more, and more preferably 2% by volume or more in the nonaqueous solvent. An upper limit thereof is preferably 10% by volume or less, more preferably 8% by volume or less, and still more preferably 6% by volume or less.

More preferably, the asymmetric linear carbonate contains an ethyl group, and methyl ethyl carbonate is especially preferred.

The aforementioned case is preferred because not only the metal elution from a positive electrode or the like at a high temperature and a high voltage can be suppressed, but also the output characteristics after cycles are improved.

From the viewpoint of improvement of electrochemical characteristics in a broad temperature range, particularly at a high temperature, a proportion of the cyclic carbonate to the linear ester is preferably from 10/90 to 45/55, more preferably from 15/85 to 40/60, and still more preferably from 20/80 to 35/65 in terms of a volume ratio of [(amount of the cyclic carbonate)/(amount of the linear ester)]. Here, the amount of the linear ester refers to an amount of the linear carbonate in the case of using only the linear carbonate, and to a sum total amount of the linear carbonate and the linear carboxylic acid ester in the case of using both the linear carbonate and the linear carboxylic acid ester.

### [Electrolyte Salt]

As the electrolyte salt that is used in the present invention, a lithium salt is suitably exemplified.

As the lithium salt, one or more selected from LiPF₆, LiBF₄, LiN(SO₂F)₂, LiN(SO₂CF₃)₂, and LiPO₂F₂ are preferred, one or more selected from LiPF₆, LiBF₄, and LiN(SO₂F)₂ are more preferred, and LiPF₆ is still more preferred.

In general, a concentration of the lithium salt is preferably 0.8 M or more, more preferably 1.0 M or more, and still more preferably 1.2 M or more relative to the aforementioned nonaqueous solvent. In addition, an upper limit thereof is preferably 1.6 Mor less, more preferably 1.5 M or less, and still more preferably 1.4 M or less.

In the electrolyte salt, in the case of using lithium difluorophosphate (LiPO₂F₂), a mass ratio of lithium hexafluorophosphate (LiPF₆) to lithium difluorophosphate (LiPF₆/LiPO₂F₂) is preferably 3 or more, more preferably 4 or more, and still more preferably 5 or more. In addition, an upper limit thereof is preferably 12 or less, more preferably 11 or less, and still more preferably 10 or less.

### [Production of Nonaqueous Electrolytic Solution]

The nonaqueous electrolytic solution of the present invention can be, for example, obtained by a method of mixing the aforementioned nonaqueous solvents, dissolving the aforementioned electrolyte salt therein to prepare a nonaqueous electrolytic solution, and adding a liquid composition of a mixture of lithium difluorophosphate and the dissolution aid in a specified mixing ratio into the nonaqueous electrolytic solution; or a method of adding lithium difluorophosphate and the dissolution aid in the nonaqueous electrolytic solution in a specified mixing ratio.

At this time, the nonaqueous solvent to be used and the compounds to be added to the nonaqueous electrolytic solution are preferably purified in advance to decrease impurities as far as possible within a range where the productivity is not remarkably worsened.

The nonaqueous electrolytic solution of the present invention may be used in the following first and second energy storage devices, in which the nonaqueous electrolyte may be used not only in the form of a liquid but also in the form of a gel. Furthermore, the nonaqueous electrolytic solution of the present invention may also be used for a solid polymer electrolyte. Above all, the nonaqueous electrolytic solution is preferably used for the first energy storage device (i.e., for a lithium battery) or for the second energy storage device (i.e., for a lithium ion capacitor) each using a lithium salt as the electrolyte salt, more preferably used for a lithium battery, and still more preferably used for a lithium secondary battery

### [First Energy Storage Device (Lithium Secondary Battery)]

The lithium secondary battery of the present invention includes a positive electrode, a negative electrode, and the aforementioned nonaqueous electrolytic solution having an electrolyte salt dissolved in a nonaqueous solvent. Other constitutional members than the nonaqueous electrolytic solution; such as the positive electrode, the negative electrode, etc., may be used without being particularly limited.

For example, as a positive electrode active material for a lithium secondary battery a complex metal oxide containing lithium and one or more selected from cobalt, manganese, and nickel is used. Such a positive electrode active material may be used solely or in combination of two or more thereof.

As such a lithium complex metal oxide, at least one selected from LiCoO₂, LiCo₁₋ₓMₓO₂ (wherein M represents one or more elements selected from Sn, Mg, Fe, Ti, Al, Zr, Cr, V, Ga, Zn, and Cu, and 0.001<x<0.05), LiMn₂O₄, LiNiO₂, LiCO₁₋ₓNiₓO₂ (0.01<x<1), LiCo_{1/3}Ni_{1/3}Mn_{1/3}O₂, LiNi_{0.5}Mn_{0.3}Co_{0.2}Mn_{0.3}O₂, LiNi_{0.8}Mn_{0.1}Co_{0.1}O₂, LiNi_{0.8}Co_{0.15}Al_{0.05}O₂, a solid solution of Li₂MnO₃ and LiMO₂ (wherein M represents a transition metal, such as Co, Ni, Mn, Fe, etc.), and LiNi_{1/2}Mn_{3/2}O₄ is suitably exemplified, and two or more thereof are more suitable. In addition, these materials may be used as a combination, such as a combination of LiCoO₂, and LiMn₂O₄, a combination of LiCoO₂, and LiNiO₂, and a combination of LiMn₂O₄ and LiNiO₂.

Among those, a lithium complex metal oxide capable of being used at 4.4 V (a charge potential of the positive electrode based on Li is 4.5 V) or more, such as LiCo_{1/3}Ni_{1/3}Mn_{1/3}O₂, LiNi_{0.5}Mn_{0.3}Co_{0.20}O₂, LiNi_{1/2}Mn_{3/2}O₄, and a solid solution of Li₂MnO₃ and LiMO₂ (wherein M represents a transition metal, such as Co, Ni, Mn, Fe, etc.), is more preferred; and LiNi_{0.5}Mn_{0.3}Co_{0.2}O₂ and LiNi_{1/2}Mn_{3/2}O₄ each having a high content of Ni are especially preferred. In the case where a positive electrode including Ni or Mn is used, the amount of Ni or Mn which elutes as a metal ion from a positive electrode increases, decomposition of the electrolytic solution on a negative electrode is promoted due to a catalytic effect of Ni or Mn deposited on the negative electrode, and electrochemical characteristics, such as high-temperature cycle property, etc., are worsened. However, the energy storage device using the nonaqueous electrolytic solution of the present invention is preferred because worsening of electrochemical characteristics, such as cycle property particularly at a high temperature, output characteristics after cycles, etc., and metal elution from a positive electrode can be suppressed.

An electroconductive agent of the positive electrode is not particularly limited so long as it is an electron-conductive material that does not undergo chemical change. For example, there are one or more carbon materials selected from graphites, such as natural graphite (e.g., flaky graphite, etc.), artificial graphite, etc.; carbon blacks, such as acetylene black, Ketjen black, channel black, furnace black, lamp black, thermal black, etc.; and carbon nanotubes. In addition, the graphite, the carbon black, and the carbon nanotube may also be appropriately mixed and used.

The amount of the electroconductive agent added to a positive electrode mixture is preferably 1 to 10% by mass, and more preferably 2 to 5% by mass.

The positive electrode may be produced in such a manner that the positive electrode active material is mixed with an electroconductive agent, such as acetylene black, carbon black, etc., and then mixed with a binder, such as polytetrafluoroethylene (PTFE), polyvinylidene fluoride (PVDF), a copolymer of styrene and butadiene (SBR), a copolymer of acrylonitrile and butadiene (NBR), carboxymethyl cellulose (CMC), an ethylene-propylene-diene terpolymer, etc., to which a high-boiling point solvent, such as 1-methyl-2-pyrrolidone, etc., is then added, followed by kneading to provide a positive electrode mixture, and the positive electrode mixture is applied onto a collector, such as an aluminum foil, a stainless steel-made lath plate, etc., dried, shaped under pressure, and then heat-treated in vacuum at a temperature of about 50° C. to 250° C. for about 2 hours.

A density of the positive electrode except for the collector is generally 1.5 g/cm³ or more, and for the purpose of further increasing a capacity of the battery, the density is preferably 2 g/cm³ or more, more preferably 3 g/cm³ or more, and still more preferably 3.6 g/cm³ or more. An upper limit thereof is preferably 4g/cm³ or less.

As a negative electrode active material for a lithium secondary battery, one or more selected from a lithium metal, a lithium alloy, a carbon material capable of absorbing and releasing lithium [e.g., graphitizable carbon, non-graphitizable carbon having a lattice (002) spacing of 0.37 nm or more, graphite having a lattice (002) spacing of 0.34 nm or less, etc.], tin (elemental substance), a tin compound, silicon (elemental substance), a silicon compound, and a lithium titanate compound, such as Li₄Ti₅O₁₂, etc., may be used. A combination of graphite and silicon, or a combination of graphite and a silicon compound, is especially preferred.

In the case where a combination of graphite and silicon, or a combination of graphite and a silicon compound, is used as the negative electrode active material, the content of silicon and the silicon compound in the whole of the negative electrode active materials is preferably 1 to 45% by mass, and more preferably 2 to 15% by mass. When the content falls within the aforementioned range, the battery capacity can be increased while suppressing worsening of the electrochemical characteristics of the lithium secondary battery according to the present invention or an increase of the electrode thickness, and hence, such is preferred.

As other negative electrode active materials for lithium secondary battery, an oxide including titanium is preferred, and a lithium titanate compound having a spinel structure, such as Li₄Ti₅O₁₂, etc., is more preferred. When an oxide including titanium as the negative electrode active material and the nonaqueous electrolytic solution of the present invention are used, the cycle property at a high temperature and the output characteristics after cycles of the lithium ion secondary battery can be much more improved, and hence, such is preferred.

When a carbon nanotube is used as an electroconductive aid, the aforementioned effects are much more easily exhibited, and hence, such is preferred.

A specific surface area of the oxide including titanium is preferably 4 m²/g or more and 100 m²/g or less, and an average particle diameter on a volume basis as determined by the laser diffraction and scattering method is preferably 0.1 μm or more and 50 μm or less.

The negative electrode may be produced in such a manner that the same electroconductive agent, binder, and high-boiling point solvent as in the production of the positive electrode as described above are used and kneaded to provide a negative electrode mixture, and the negative electrode mixture is then applied on a collector, such as a copper foil, etc., dried, shaped under pressure, and then heat-treated in vacuum at a temperature of about 50° C. to 250° C. for about 2 hours.

A density of the negative electrode except for the collector is generally 1.1 g/cm³ or more, and for the purpose of further increasing a capacity of the battery, the density is preferably 1.5 g/cm³ or more. An upper limit thereof is preferably 2 g/cm³ or less.

Although a separator for battery is not particularly limited, a single-layered or laminated micro-porous film of a polyolefin, such as polypropylene, polyethylene, an ethylene-propylene copolymer, etc., a woven fabric, a nonwoven fabric, or the like may be used. The laminate of a polyolefin is preferably a laminate of polyethylene and polypropylene, and above all, a three-layered structure of polypropylene/polyethylene/polypropylene is more preferred.

A thickness of the separator is preferably 2 μm or more, more preferably 3 μm or more, and still more preferably 4 μm or more. In addition, an upper limit thereof is preferably 30 μm or less, more preferably 20 μm or less, and still more preferably 15 μm or less.

The structure of the lithium battery is not particularly limited, and a coin-type battery, a cylinder-type battery, a prismatic battery, a laminate-type battery, or the like may be applied.

The lithium secondary battery in the present invention has excellent electrochemical characteristics in a broad temperature range even when a final charging voltage is 4.2 V or more, particularly 4.3 V or more, and furthermore, the characteristics are favorable even at 4.4 V or more. A final discharging voltage may be generally 2.8 V or more, and furthermore 2.5 V or more, and the final discharging voltage of the lithium secondary battery in the present invention may be 2.0 V or more. An electric current value is not particularly limited, and in general, the battery may be used within a range of from 0.1 to 30 C. In addition, the lithium battery in the present invention may be charged and discharged at −40 to 100° C., and preferably −10 to 80° C.

In the present invention, as a countermeasure against the increase in the internal pressure of the lithium battery, there may also be adopted such a method that a safety valve is provided in a battery cap, or a cutout is provided in a component, such as a battery can, a gasket, etc. In addition, as a safety countermeasure for prevention of overcharging, a circuit cut-off mechanism capable of detecting the internal pressure of the battery to cut off the electric current may be provided in the battery cap.

### [Second Energy Storage Device (Lithium Ion Capacitor)]

The second energy storage device of the present invention is an energy storage device including the nonaqueous electrolytic solution of the present invention and storing energy by utilizing intercalation of a lithium ion into a carbon material, such as graphite, etc., as the negative electrode. This energy storage device is called a lithium ion capacitor (LIC). As the positive electrode, there are suitably exemplified one utilizing an electric double layer between an active carbon electrode and an electrolytic solution, one utilizing a doping/dedoping reaction of a it-conjugated polymer electrode, and the like. The electrolytic solution includes at least a lithium salt, such as LiPF₆, etc.

In the lithium ion capacitor, by using, as the negative electrode material, a lithium titanate or a carbon material in which a lithium ion is absorbed or doped in advance in place of the active carbon, a negative electrode potential may be kept lower than that of a usual electric double layer capacitor. For that reason, the range of a voltage used of the cell can be widened.

Using the nonaqueous electrolytic solution of the present invention, it is possible to provide a lithium ion capacitor that is excellent in high-temperature cycle property and output characteristics after high-temperature cycles.

### EXAMPLES

### Preparation Examples 1 to 9

### [Preparation of Compositions of Lithium Difluorophosphate and Various Solvents (Dissolution Aids)]

Lithium difluorophosphate was mixed with a solvent as described in Table 1 in a molar ratio of 1.5, 2.5, 7, and 10, respectively, and the mixture was stirred at room temperature for 6 hours in an argon atmosphere, thereby preparing liquid compositions.

The case where a completely uniform liquid composition without causing an undissolved residue of lithium difluorophosphate was obtained is designated as “A” (possible for preparation); the case where a substantially uniform liquid composition was obtained is designated as “B” (possible for preparation); and the case where lithium difluorophosphate remained undissolved is designated as “C” (impossible for preparation).

The results are shown in Table 1.

TABLE 1

| | | | Miscibility of | | | |
|---|---|---|---|---|---|---|
| | Solvent (dissolution aid) | | solvent/LiPO2F2 | | | |
| | | Molecular | (mol/mol) | | | |
| | Kind | weight | 1.5 | 2.5 | 7 | 10 |
| Preparation | Dimethoxyethane | 90 | B | A | A | A |
| Example 1 | | | | | | |
| Preparation | Diethylene glycol dimethyl | 134 | C | C | C | A |
| Example 2 | ether | | | | | |
| Preparation | Triethylene glycol dimethyl | 178 | A | A | A | A |
| Example 3 | ether | | | | | |
| Preparation | Tetraethylene glycol | 222 | A | A | A | A |
| Example 4 | dimethyl ether | | | | | |
| Preparation | Diethoxyethane | 118 | C | C | C | C |
| Example 5 | | | | | | |
| Preparation | Tetrahydrofuran | 72 | C | C | C | C |
| Example 6 | | | | | | |
| Preparation | 1,3-Dioxolane | 74 | C | C | C | C |
| Example 7 | | | | | | |
| Preparation | Acetonitrile | 41 | C | C | C | C |
| Example 8 | | | | | | |
| Preparation | Propionitrile | 55 | C | C | C | C |
| Example 9 | | | | | | |

From Table 1, it is noted that in the case of using, as the solvent (dissolution aid), triethylene glycol dimethyl ether or tetraethylene glycol dimethyl ether, a uniform liquid composition with lithium difluorophosphate can be prepared in a broad range. In addition, in the case of using, as the solvent, dimethoxyethane or diethylene glycol dimethyl ether, a uniform liquid composition with lithium difluorophosphate could be prepared in a specified range.

In addition, from Preparation Examples 5 to 9, it has become clear that the solvent having a dielectric constant of 5 or more and a viscosity rate of 0.6 cP or less, as described in PTL 1, such as diethoxyethane, acetonitrile, propionitrile, etc., the cyclic ether compound, and so on are not suited as the dissolution aid of lithium difluorophosphate.

### Examples 1 to 12 and 25, Reference Examples 13 to 24, and Comparative Examples 1 to 4

[Production of Lithium Ion Secondary Battery] 94% by mass of LiNi_{0.5}Mn_{0.3}Co_{0.2}O₂ and 3% by mass of acetylene black (electroconductive agent) were mixed, and the mixture was then added to and mixed with a solution which had been prepared by dissolving 3% by mass of polyvinylidene fluoride (binder) in 1-methyl-2-pyrrolidone in advance, followed by mixing, thereby preparing a positive electrode mixture paste. This positive electrode mixture paste was applied onto one surface of an aluminum foil (collector), dried, and treated under pressure, followed by cutting into a predetermined size, thereby producing a positive electrode sheet in a belt-like form. A density of the positive electrode except for the collector was 3.6 g/cm³.

10% by mass of silicon (elemental substance), 80% by mass of artificial graphite (d₀₀₂=0.335 nm, negative electrode active material), and 5% by mass of acetylene black (electroconductive agent) were mixed, and the mixture was then added to and mixed with a solution which had been prepared by dissolving 5% by mass of polyvinylidene fluoride (binder) in 1-methyl-2-pyrrolidone in advance, thereby preparing a negative electrode mixture paste. This negative electrode mixture paste was applied onto one surface of a copper foil (collector), dried, and treated under pressure, followed by cutting into a predetermined size, thereby producing a negative electrode sheet. A density of the negative electrode except for the collector was 1.5 g/cm³.

This electrode sheet was analyzed by X-ray diffractometry. As a result, a ratio [I(110)/I(004)] of the peak intensity I(110) of the (110) plane to the peak intensity I(004) of the (004) plane of the graphite crystal was 0.1.

The above-obtained positive electrode sheet, a micro-porous polyethylene film-made separator, and the above-obtained negative electrode sheet were laminated in this order, and a nonaqueous electrolytic solution having each of compositions shown in Tables 2 and 3 was stirred at room temperature for 10 minutes then added, thereby producing a laminate-type battery.

### [Evaluation of High-Temperature Cycle Property]

In a thermostatic chamber at 50° C., the laminate-type battery produced by the aforementioned method was charged up to a final voltage of 4.4 V (a potential of the positive electrode based on Li is 4.5 V) with a constant current of 1 C and under a constant voltage for 3 hours and then discharged down to a discharge voltage of 3.0 V with a constant current of 1 C. This operation was defined by one cycle and repeated until reaching 200 cycles. A discharge capacity retention rate after cycles was determined according to the following equation, thereby evaluating the high-temperature cycle property.

Discharge capacity retention rate (%)={(Discharge capacity at 200th cycle)/(Discharge capacity at 1st cycle)}×100

[Evaluation of Output Characteristics after High-Temperature Cycles]

In a thermostatic chamber at 25° C., the laminate-type battery after high-temperature cycles was charged up to a final voltage of 4.4 V with a constant current of 1 C and under a constant voltage for 3 hours and then discharged down to a discharge voltage of 3.0 V with a constant current of 1 C (IC capacity). Thereafter, the resulting battery was charged up to a final voltage of 4.4 V with a constant current of 1 C and under a constant voltage for 3 hours and then discharged down to a final voltage of 3.0 V with a constant current of 5 C (5C capacity). A capacity ratio thereof {(5C capacity)/(1C capacity)} was defined as the output characteristics after cycles.

As for the output characteristics after high-temperature cycles, relative output characteristics were evaluated on a basis when the output characteristics of Comparative Example 1 were defined as 100%.

[Evaluation of Metal Elution Amount after High-Temperature Cycles]

The metal elution amount after high-temperature cycles was determined by identifying an amount of a metal electrodeposited on the negative electrode. As for the amount of a metal electrodeposited on the negative electrode, a negative electrode sheet obtained by disassembling the laminate-type battery after high-temperature cycles and washing was dissolved in an acid, and thereafter, the metal elution amount in a total amount of Ni, Mn, and Co was analyzed by the ICP (inductively coupled plasma) optical emission spectroscopy (with “SPS3520UV”, manufactured by Hitachi High-Tech Science Corporation).

As for the metal elution amount, a relative metal elution amount was evaluated on a basis when the total metal elution amount of Ni, Mn, and Co of Comparative Example 1 was defined as 100%.

The production conditions and battery characteristics of battery are shown in Tables 2 and 3.

In Tables 2 and 3, the “Dissolved amount of LiPO₂F₂” is synonymous with the content in the nonaqueous electrolytic solution, and the same is also applicable in Tables 4 and 5. The matter that LiPO₂F₂ was completely dissolved was confirmed through visual inspection.

EA in Reference Example 24 in Table 3 means ethyl acetate.

TABLE 2

| | | | | | | | | | Evaluation results of | | |
|---|---|---|---|---|---|---|---|---|---|---|---|
| | | Dissolution aid | | Nonaqueous electrolytic solution | | | | | high-temperature cycle property | | |
| | | | Content in | | | Dissolution | | | Discharge | | |
| | Composition of electrolyte salt | | nonaqueous | Dissolved | | aid | | | capacity | | |
| | Composition of nonaqueous | | electrolytic | amount of | Dissolution aid/ | (% by volume)/ | Dissolution aid/ | LiPF6/ | retention | Output | Metal elution |
| | electrolytic solution | | solution | LiPO2F2 | LiPO2F2 | LiPO2F2 | LiPO2F2 | LiPO2F2 | rate | characteristics | amount |
| | (Volume ratio of solvent) | Kind | (% by mass) | (% by mass) | (molar ratio) | (% by mass) | (mass ratio) | (mass ratio) | (%) | (%) | (%) |
| Example 1 | 1.2M LiPF6 | Triethylene | 3.3 | 2 | 1 | 2.1 | 1.7 | 7.3 | 74 | 133 | 68 |
| | EC/MEC | glycol dimethyl ether | | | | | | | | | |
| | (30/70) | | | | | | | | | | |
| Example 2 | 1.2M LiPF6 | | 2.6 | 1.5 | 1 | 2.2 | 1.7 | 9.7 | 78 | 137 | 65 |
| | EC/VC/DMC/MEC | | | | | | | | | | |
| | (29/1/45/25) | | | | | | | | | | |
| Example 3 | 1.2M LiPF6 | | 3.3 | 2 | 1 | 2.1 | 1.7 | 7.3 | 80 | 140 | 63 |
| | EC/VC/DMC/MEC | | | | | | | | | | |
| | (29/1/45/25) | | | | | | | | | | |
| Example 4 | 1.2M LiPF6 | | 5.1 | 3 | 1 | 2.1 | 1.7 | 4.8 | 72 | 131 | 71 |
| | EC/VC/DMC/MEC | | | | | | | | | | |
| | (29/1/45/25) | | | | | | | | | | |
| Example 5 | 1.2M LiPF6 | | 8.5 | 5 | 1 | 2.0 | 1.7 | 2.9 | 70 | 129 | 75 |
| | EC/VC/DMC/MEC | | | | | | | | | | |
| | (29/1/45/25) | | | | | | | | | | |
| Example 6 | 1.2M LiPF6 | | 1.7 | 2 | 0.5 | 1.1 | 0.9 | 7.3 | 76 | 134 | 66 |
| | EC/VC/DMC/MEC | | | | | | | | | | |
| | (29/1/45/25) | | | | | | | | | | |
| Example 7 | 1.2M LiPF6 | | 2.3 | 2 | 0.7 | 1.5 | 1.2 | 7.3 | 78 | 138 | 64 |
| | EC/VC/DMC/MEC | | | | | | | | | | |
| | (29/1/45/25) | | | | | | | | | | |
| Example 8 | 1.2M LiPF6 | | 4 | 2 | 1.2 | 2.5 | 2.0 | 7.3 | 73 | 132 | 68 |
| | EC/VC/DMC/MEC | | | | | | | | | | |
| | (29/1/45/25) | | | | | | | | | | |
| Example 9 | 1.2M LiPF6 | | 5.1 | 2 | 1.5 | 3.2 | 2.6 | 7.3 | 71 | 129 | 70 |
| | EC/VC/DMC/MEC | | | | | | | | | | |
| | (29/1/45/25) | | | | | | | | | | |
| Example 10 | 1.2M LiPF6 | | 6 | 2 | 1.8 | 3.7 | 3.0 | 7.3 | 69 | 127 | 72 |
| | EC/VC/DMC/MEC | | | | | | | | | | |
| | (29/1/45/25) | | | | | | | | | | |
| Example 11 | 1.2M LiPF6 | | 2.6 | 3 | 0.5 | 1.1 | 0.9 | 4.8 | 79 | 139 | 62 |
| | EC/VC/DMC/MEC | | | | | | | | | | |
| | (29/1/45/25) | | | | | | | | | | |
| Example 12 | 1.2M LiPF6 | Tetraethylene | 3 | 1.5 | 1 | 2.6 | 2.0 | 9.7 | 76 | 135 | 72 |
| | EC/VC/DMC/MEC | glycol dimethyl ether | | | | | | | | | |
| | (29/1/45/25) | | | | | | | | | | |
| Reference | 1.2M LiPF6 | Dimethoxy | 2.5 | 1.5 | 2 | 2.4 | 1.7 | 9.7 | 75 | 134 | 75 |
| Example 13 | EC/VC/DMC/MEC | ethane | | | | | | | | | |
| | (29/1/45/25) | | | | | | | | | | |
| Reference | 1.2M LiPF6 | | 3.3 | 2 | 2 | 2.4 | 1.7 | 7.3 | 76 | 135 | 71 |
| Example 14 | EC/VC/DMC/MEC | | | | | | | | | | |
| | (29/1/45/25) | | | | | | | | | | |
| Reference | 1.2M LiPF6 | | 5.0 | 3 | 2 | 2.4 | 1.7 | 4.8 | 70 | 130 | 83 |
| Example 15 | EC/VC/DMC/MEC | | | | | | | | | | |
| | (29/1/45/25) | | | | | | | | | | |
| Reference | 1.2M LiPF6 | | 8.4 | 5 | 2 | 2.3 | 1.7 | 2.9 | 68 | 126 | 85 |
| Example 16 | EC/VC/DMC/MEC | | | | | | | | | | |
| | (29/1/45/25) | | | | | | | | | | |
| Reference | 1.2M LiPF6 | | 0.9 | 2 | 0.5 | 0.7 | 0.5 | 7.3 | 72 | 131 | 79 |
| Example 17 | EC/VC/DMC/MEC | | | | | | | | | | |
| | (29/1/45/25) | | | | | | | | | | |
| Reference | 1.2M LiPF6 | | 1.7 | 2 | 1 | 1.3 | 0.9 | 7.3 | 73 | 133 | 77 |
| Example 18 | EC/VC/DMC/MEC | | | | | | | | | | |
| | (29/1/45/25) | | | | | | | | | | |
| Reference | 1.2M LiPF6 | | 2 | 2 | 1.2 | 1.5 | 1.0 | 7.3 | 74 | 133 | 75 |
| Example 19 | EC/VC/DMC/MEC | | | | | | | | | | |
| | (29/1/45/25) | | | | | | | | | | |
| Reference | 1.2M LiPF6 | | 2.7 | 2 | 1.6 | 2.0 | 1.4 | 7.3 | 75 | 134 | 73 |
| Example 20 | EC/VC/DMC/MEC | | | | | | | | | | |
| | (29/1/45/25) | | | | | | | | | | |
| Reference | 1.2M LiPF6 | | 3.7 | 2 | 2.2 | 2.7 | 1.9 | 7.3 | 69 | 128 | 85 |
| Example 21 | EC/VC/DMC/MEC | | | | | | | | | | |
| | (29/1/45/25) | | | | | | | | | | |
| Reference | 1.2M LiPF6 | | 4.1 | 2 | 2.4 | 2.9 | 2.1 | 7.3 | 66 | 125 | 87 |
| Example 22 | EC/VC/DMC/MEC | | | | | | | | | | |
| | (29/1/45/25) | | | | | | | | | | |
| Reference | 1.2M LiPF6 | | 2.6 | 3 | 1 | 1.3 | 0.9 | 4.8 | 75 | 134 | 76 |
| Example 23 | EC/VC/DMC/MEC | | | | | | | | | | |
| | (29/1/45/25) | | | | | | | | | | |
| Reference | 1.2M LiPF6 | | 3.3 | 2 | 2 | 2.4 | 1.7 | 7.3 | 81 | 137 | 70 |
| Example 24 | EC/VC/DMC/MEC/EA | | | | | | | | | | |
| | (29/1/42/25/3) | | | | | | | | | | |
| Example 25 | 1.2M LiPF6 | TG* | 3.4 | 2 | 1.5 | 2.2 | 1.7 | 7.3 | 80 | 139 | 69 |
| | EC/VC/DMC/MEC | (1.7 wt %) + | | | | | | | | | |
| | (29/1/45/25) | dimethoxy ethane | | | | | | | | | |
| | | (1.7 wt %) | | | | | | | | | |
| Comparative | 1.2M LiPF6 | — | — | — | — | — | — | 8.4 | 57 | 100 | 100 |
| Example 1 | EC/VC/DMC/MEC | | | | | | | | | | |
| | (29/1/45/25) | | | | | | | | | | |
| Comparative | 1.2M LiPF6 | — | — | 1 | — | — | — | 14.5 | 62 | 115 | 98 |
| Example 2 | EC/VC/DMC/MEC | | | | | | | | | | |
| | (29/1/45/25) | | | | | | | | | | |
| Comparative | 1.2M LiPF6 | Dimethoxy | 1.7 | 1 | 2 | 2.5 | 1.7 | 14.5 | 64 | 120 | 97 |
| Example 3 | EC/VC/DMC/MEC | ethane | | | | | | | | | |
| | (29/1/45/25) | | | | | | | | | | |
| Comparative | 1M LiPF6 | Dimethoxy | 3.7 | 0.5 | 4.5 | 10 | 7.4 | 29.0 | 60 | 105 | 96 |
| Example 4 | EC/MEC/DME | ethane | | | | | | | | | |
| | (30/65/5) | | | | | | | | | | |

*TG: Triethylene glycol dimethyl ether

### Example 26, Reference Example 27, and Comparative Example 5

A positive electrode sheet was produced by using LiNi_{1/2}Mn_{3/2}O₄ (positive electrode active material) in place of the positive electrode active material used in Example 1 and Comparative Example 1. 94% by mass of LiNi_{1/2}Mn_{3/2}O₄ coated with amorphous carbon and 3% by mass of acetylene black (electroconductive agent) were mixed, and the mixture was then added to and mixed with a solution which had been prepared by dissolving 3% by mass of polyvinylidene fluoride (binder) in 1-methyl-2-pyrrolidone in advance, thereby preparing a positive electrode mixture paste. A laminate-type battery was produced and subjected to battery evaluation in the same manners as in Example 1 and Comparative Example 1, except that this positive electrode mixture paste was applied onto one surface of an aluminum foil (collector), dried, and treated under pressure, followed by cutting into a predetermined size, thereby producing a positive electrode sheet.

The metal elution amount was determined on a basis when the metal elution amount of Comparative Example 5 was defined as 100%.

The results are shown in Table 4.

TABLE 4

| | | Dissolution aid | | Nonaqueous electrolytic solution | | |
|---|---|---|---|---|---|---|
| | Composition of electrolyte salt | | Content in | Dissolved | | Dissolution aid |
| | Composition of nonaqueous | | nonaqueous | amount of | Dissolution aid/ | (% by volume)/ |
| | electrolytic solution | | electrolytic solution | LiPO2F2 | LiPO2F2 | LiPO2F2 |
| | (Volume ratio of solvent) | Kind | (% by mass) | (% by mass) | (molar ratio) | (% by mass) |
| Example 26 | 1.2M LiPF6 | TG* | 3.3 | 2 | 1 | 2.1 |
| Reference | EC/FEC/MEC/DEC | Dimethoxy | 3.3 | 2 | 2 | 2.4 |
| Example 27 | (20/10/25/45) | ethane | | | | |
| Comparative | | — | — | — | — | — |
| Example 5 | | | | | | |

| | | | Evaluation results of | | |
|---|---|---|---|---|---|
| | Nonaqueous | | high-temperature cycle property | | |
| | electrolytic solution | | Discharge | | |
| | Dissolution aid/ | LiPF6/ | capacity | Output | Metal elution |
| | LiPO2F2 | LiPO2F2 | retention rate | characteristics | amount |
| | (mass ratio) | (mass ratio) | (%) | (%) | (%) |
| Example 26 | 1.7 | 7.3 | 67 | 153 | 67 |
| Reference | 1.7 | 7.3 | 65 | 150 | 65 |
| Example 27 | | | | | |
| Comparative | — | — | 50 | 100 | 50 |
| Example 5 | | | | | |

*TG: Triethylene glycol dimethyl ether

### Example 28, Reference Example 29, and Comparative Example 6

A negative electrode sheet was produced by using lithium titanate (Li₄Ti₅O₁₂; negative electrode active material) in place of the negative electrode active material used in Example 1 and Comparative Example 1.

90% by mass of lithium titanate, 4% by mass of acetylene black (electroconductive agent), and 1% by mass of carbon nanotube (electroconductive agent) were mixed, and the mixture was then added to and mixed with a solution which had been prepared by dissolving 5% by mass of polyvinylidene fluoride (binder) in 1-methyl-2-pyrrolidone in advance, thereby preparing a negative electrode mixture paste. A laminate-type battery was produced and subjected to battery evaluation in the same manners as in Example 1 and Comparative Example 1, except that this negative electrode mixture paste was applied onto an aluminum foil (collector), dried, and treated under pressure, followed by cutting into a predetermined size, thereby producing a negative electrode sheet; that in evaluating the battery, the final charging voltage and the final discharging voltage were set to 2.8 V and 1.2 V, respectively; and that the composition of the nonaqueous electrolytic solution was changed to a predetermined composition. The results are shown in Table 5.

TABLE 5

| | | Dissolution aid | | Nonaqueous electrolytic solution | | |
|---|---|---|---|---|---|---|
| | Composition of electrolyte salt | | Content in | Dissolved | | Dissolution aid |
| | Composition of nonaqueous | | nonaqueous | amount of | Dissolution aid/ | (% by volume)/ |
| | electrolytic solution | | electrolytic solution | LiPO2F2 | LiPO2F2 | LiPO2F2 |
| | (Volume ratio of solvent) | Kind | (% by mass) | (% by mass) | (molar ratio) | (% by mass) |
| Example 28 | 1.2M LiPF6 | TG* | 3.3 | 2 | 1 | 2.1 |
| Reference | PC/DEC | Dimethoxy | 3.3 | 2 | 2 | 2.4 |
| Example 29 | (30/70) | ethane | | | | |
| Comparative | | — | — | — | — | — |
| Example 6 | | | | | | |

| | | | Evaluation results of | | |
|---|---|---|---|---|---|
| | Nonaqueous | | high-temperature cycle property | | |
| | electrolytic solution | | Discharge | | |
| | Dissolution aid/ | LiPF6/ | capacity | Output | Metal elution |
| | LiPO2F2 | LiPO2F2 | retention rate | characteristics | amount |
| | (mass ratio) | (mass ratio) | (%) | (%) | (%) |
| Example 28 | 1.7 | 7.3 | 93 | 155 | 65 |
| Reference | 1.7 | 7.3 | 91 | 152 | 67 |
| Example 29 | | | | | |
| Comparative | — | — | 80 | 100 | 100 |
| Example 6 | | | | | |

*TG: Triethylene glycol dimethyl ether

### Comparative Example 7

To 47.70 g of the electrolytic solution used in Comparative Example 1, 2.30 g (4.6% by mass) of lithium difluorophosphate was added, and the mixture was then stirred at 25° C. for 10 minutes. The undissolved lithium difluorophosphate was filtered with a PTFE resin-made membrane filter, and the resultant was quantitated by means of ion chromatography. As a result, the amount of lithium difluorophosphate contained in the electrolytic solution was 0.53 g (1.1% by mass).

All of the lithium secondary batteries of Examples 1 to 12, 25, 26, and 28 each using the nonaqueous electrolytic solution containing dimethoxyethane or triethylene glycol dimethyl ether, and lithium difluorophosphate in a specified ratio are improved with respect to the high-temperature cycle property, the output characteristics after high-temperature cycles, and the effect for suppressing metal elution from a positive electrode, as compared with the lithium secondary batteries of Comparative Examples 1 to 6.

In addition, though Example 3 and Reference Example 14 are concerned with an example where the content of the dissolution aid is 3.3%, it is noted that the electrolytic solution using triethylene glycol dimethyl ether (Example 3) is more excellent in the discharge capacity retention rate (%) by 4%, more excellent in the output characteristics by 5%, and smaller in the metal elution amount by 8% than the electrolytic solution using dimethoxyethane (Reference Example 14).

In addition, from comparison of Reference Examples 13 to 24 with Comparative Examples 3 and 4, it is noted that when the ratio (% by volume/% by mass) of a proportion (% by volume) of the dissolution aid to the total volume of the nonaqueous solvent to the amount (% by mass) of lithium difluorophosphate in the nonaqueous electrolytic solution is 10 or more, for example, as described in Examples of PTL 1, the effects of the present invention are not obtained.

In the light of the above, it has become clear that the peculiar effects of the present invention are a peculiar effect in the case where lithium difluorophosphate and a specified dissolution aid are contained in a specified ratio, and the lithium difluorophosphate is dissolved in an amount of 1.2% by mass or more in the nonaqueous electrolytic solution.

In addition, from comparison of Example 26 and Reference Example 27 with Comparative Example 5 and comparison of Example 28 and Reference Example 29 with Comparative Example 6, even in the case of using LiNi_{1/2}Mn_{3/2}O₄ for the positive electrode, or in the case of using lithium titanate (Li₄Ti₅O₁₂) for the negative electrode, the same effects are brought.

Furthermore, in the case of not using the dissolution aid in Comparative Example 7, the mass of lithium difluorophosphate completely dissolved in the electrolytic solution was less than 1.2% by mass or less relative to the electrolytic solution.

### INDUSTRIAL APPLICABILITY

When the nonaqueous electrolytic solution of the present invention is used, it is possible to obtain an energy storage device which is excellent in high-temperature cycle property and output characteristics after high-temperature cycles and is capable of suppressing metal elution from a positive electrode or the like. In particular, when the nonaqueous electrolytic solution of the present invention is used as a nonaqueous electrolytic solution for an energy storage device, such as a lithium secondary battery, a lithium ion capacitor, etc., to be mounted on an instrument having high possibility to be used at a high temperature, such as a hybrid electric vehicle, a plug-in hybrid electric vehicle, a battery electric vehicle, a tablet device, an ultrabook, etc., it is possible to obtain an energy storage device which is excellent in high-temperature cycle property and output characteristics after high-temperature cycles and is capable of suppressing metal elution from a positive electrode or the like.

The nonaqueous electrolytic solution of the present invention has an energy-saving effect because it is able to obtain an energy storage device which is excellent in electrochemical characteristics, such as cycle property, etc.

1. A nonaqueous electrolytic solution, comprising:
a nonaqueous solvent comprising a cyclic carbonate and a linear carbonate;
lithium hexafluorophosphate dissolved in the nonaqueous solvent; and
a dissolution aid of lithium difluorophosphate,
wherein the dissolution aid is at least one selected from the group consisting of triethylene glycol dimethyl ether and tetraethylene glycol dimethyl ether,
a ratio of a proportion of the dissolution aid to the total volume of the nonaqueous solvent to an amount of the lithium difluorophosphate in the nonaqueous electrolytic solution is 0.1 or more and 5 or less; and
the lithium difluorophosphate is dissolved in an amount of 1.2% by mass or more at 25° C.

2. The nonaqueous electrolytic solution according to claim 1, comprising 1.1% by mass or more and 10% by mass or less of the dissolution aid.

3. The nonaqueous electrolytic solution according to claim 1, wherein a molar ratio of the dissolution aid to the lithium difluorophosphate is 0.1 or more and 2.5 or less.

4. The nonaqueous electrolytic solution according to claim 1, wherein a mass ratio of the dissolution aid to the lithium difluorophosphate is 0.1 or more and 5 or less.

5. The nonaqueous electrolytic solution according to claim 1, further comprising a linear carboxylic acid ester.

6. The nonaqueous electrolytic solution according to claim 5, wherein the linear carboxylic acid ester is ethyl acetate.

7. The nonaqueous electrolytic solution according to claim 1, wherein a volume ratio of [(amount of the cyclic carbonate)/(amount of the linear carbonate)] is from 10/90 to 45/55.

8. A lithium ion secondary battery comprising:
the nonaqueous electrolytic solution according to claim 1.

9. A lithium ion capacitor comprising:
the nonaqueous electrolytic solution according to claim 1.

10. The nonaqueous electrolytic solution according to claim 1,
wherein the cyclic carbonate is at least two selected from the group consisting of ethylene carbonate, propylene carbonate, 4-fluoro-1,3-dioxolan-2-one, and vinylene carbonate.

11. The nonaqueous electrolytic solution according to claim 1,
wherein a mass ratio of the lithium hexafluorophosphate to the lithium difluorophosphate (LiPF₆/LiPO₂F₂) is 3 or more.
